(19) United States
(12) Patent Application Publication
(10) Pub. No.: US 2010/0215197 A1
(43) Pub. Date: Aug. 26, 2010

(54) FLEXIBLE ELECTRET ACTUATORS AND METHODS OF MANUFACTURING THE SAME

(75) Inventors: Chih-Kung Lee, Taipei City (TW); Wen-Ching Ko, Kaohsiung City (TW); Jia-Lun Chen, Tainan City (TW); Wen-Hsin Hsiao, Longtan Township (TW); Wen-Jong Wu, Taipei City (TW)

Correspondence Address: LOWE HAUPTMAN HAM & BERNER, LLP, 1700 DIAGONAL ROAD, SUITE 300, ALEXANDRIA, VA, 22314, US

(73) Assignee: National Taiwan University

(21) Appl. No.: 12/186,730

(22) Filed: Aug. 6, 2008

Related U.S. Application Data
(60) Provisional application No. 61/035,300, filed on Mar. 10, 2008.

(30) Foreign Application Priority Data
Jan. 4, 2008 (TW) 097100279

(51) Int. Cl. H04R 25/00

(52) U.S. Cl. 381/191

(57) ABSTRACT

A flexible actuator comprises a thin film and at least one first enclosure with at least one first bendable element coupled to the first enclosure. The thin film may comprise a conductive layer and a first electret layer over a first surface of the conductive layer. The thin film is configured to be bendable. The first enclosure have a first electrode layer as part of the first enclosure. The first enclosure is provided over the first electret layer with the first electrode layer being spaced apart from the first electret layer. The first electrode layer is coupled with a first terminal of an audio signal input. The thin film is configured to interact with the first enclosure in response to audio signals supplied by the audio signal input and to generate sound waves.

### INCORPORATION BY REFERENCE

U.S. Provisional Patent Application No. 61/035,300, titled “Electret Materials, Electret Speakers, and Methods of Manufacturing the Same” is incorporated by reference herein.

### BACKGROUND OF THE INVENTION

1. Field of the Invention

This invention relates to actuators, and more particularly, to flexible electret actuators and methods of manufacturing the same.

2. Background of the Invention

In the recent years, there have been continued developments for electronic products. One design concept for those developments has been providing lightweight, thin, portable, and/or small devices. In this regard, flexible electronic technology has been increasingly used in various applications, such as LCDs, flex circuits and flexible solar cells. Applications for flexible electronics, such as flexible speakers, may benefit from their low profile, reduced weight, and/or low manufacturing cost.

A loudspeaker may produce sound by converting electrical signals from an audio amplifier into mechanical motions. Moving-coil speakers are widely used currently, which may produce sound from the forward and backward motions of a cone that is attached to a coil of wire suspended in or movably coupled with a magnetic field. A current flowing through the coil may induce a varying magnetic field around the coil. The interaction of the two magnetic fields causes relative movements of the coil, thereby moving the cone back and forth. This compresses and decompresses the air, and thus generating sound waves. Due to structural limitations, moving-coil speakers are less likely to be made flexible or in a low profile.

An electrostatic speaker may operate on the principle of Coulomb's law that two conductors with equal and opposite charge may generate a push-pull force between them. The push-pull electrostatic force may cause vibration of a diaphragm, thereby generating sound. An electrostatic speaker may include two porous electrodes and a diaphragm placed between the electrodes to form a series of capacitors. The electrodes and the diaphragm may be separated by dielectric materials. The low-profile and lightweight diaphragm makes the electrostatic speaker superior to other types of speakers, such as dynamic, moving-coil or piezoelectric speakers, with respect to its transition response, expansion capability in high frequency, smoothness of sound, acoustic fidelity and low distortion.

With the simple structure, electrostatic speakers may be manufactured in various sizes to accommodate increasing demands for small and thin electronic devices. However, some electrostatic speakers may require a DC-DC converters for providing high voltage to the speakers. Considering the size, cost and power consumption of DC-DC converters, some electret materials have been developed to reduce or avoid the need of DC-DC converters.

FIG. 1 illustrates an exemplary electret speaker, which may include porous electrodes 110a and 110b with a number of holes 112a and 112b on each electrode having a porosity of at least 30 percent. The electrodes 110a and 10b may be made of metals or plastic materials coated with a conductive film. The holes 112a and 112b may be provided for allowing sound waves to pass through them. The electret speaker may further include a diaphragm 120, which may include a conductive layer 122 sandwiched between electret layers 124a and 124b. The electret layers 124a and 124b may store positive or negative charges. The electrodes 110a and 110b, and diaphragm 120 may be held in place by holding members 130a and 130b. Elements 140a, 140b, 142a and 142b may be made of insulating materials and may be used for separating the diaphragm 120 from the electrode plates 110a and 110b to form cavities 150a and 150b for the diaphragm 120 to vibrate.

In operating of an electret speaker of FIG. 1, each signal source 160a and 160b may output equal and opposite alternating signals to the electrodes 110a and 110b via conductive lines 162a and 162b. The signals may cause a time-varying electric field to develop between the electrodes 110a and 110b and the electret layers 124a and 124b, thus resulting in a push-pull force. The push-pull force may cause the diaphragm 120 to vibrate, resulting in sound waves that may pass through holes 112a and 112b.

### BRIEF SUMMARY OF THE INVENTION

One example consistent with the invention provides a flexible actuator that may comprise a thin film and at least one first enclosure with at least one first bendable element coupled to the first enclosure. The thin film may comprise a conductive layer and a first electret layer over a first surface of the conductive layer. The thin film is configured to be bendable. The first enclosure has a first electrode layer as part of the first enclosure. The first enclosure is provided over the first electret layer with the first electrode layer being spaced apart from the first electret layer. The first electrode layer is coupled with a first terminal of an audio signal input. The thin film is configured to interact with the first enclosure in response to audio signals supplied by the audio signal input and to generate sound waves.

In another example consistent with the invention, a flexible actuator may comprise a thin film and at least one first enclosure with at least one first bendable element coupled to the first enclosure. The thin film may comprise a conductive layer. The thin film is configured to be bendable. The first enclosure has a first electrode layer and a first electret layer as part of the first enclosure. The first electrode layer is coupled with a first terminal of an audio signal input. The thin film is configured to interact with the first enclosure in response to audio signals supplied by the audio signal input and to generate sound waves.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The foregoing summary, as well as the following detailed description of the invention, will be better understood when read in conjunction with the appended, exemplary drawings. It should be understood, however, that the invention is not limited to the precise arrangements and instrumentalities shown.

In the drawings:

FIG. 1 is a sectional view of an exemplary electret speaker in the prior art;

FIG. 2 is a sectional view of an exemplary flexible electret actuator in examples consistent with the present invention;

FIG. 3 is a detailed section view of portions of an exemplary flexible electret actuator in examples consistent with the present invention;

FIG. 4 is a detailed section view of portions of an exemplary flexible electret actuator in examples consistent with the present invention;

FIG. 5 is a sectional view of an exemplary flexible electret actuator in examples consistent with the present invention;

FIG. 6 is a sectional view of an exemplary flexible electret actuator in examples consistent with the present invention;

FIG. 7 is a sectional view of an exemplary flexible electret actuator in examples consistent with the present invention;

FIG. 8 is a top view of an exemplary application of an exemplary flexible electret actuator in examples consistent with the present invention; and

FIG. 9 is a side view of an exemplary application of an exemplary flexible electret actuator in examples consistent with the present invention.

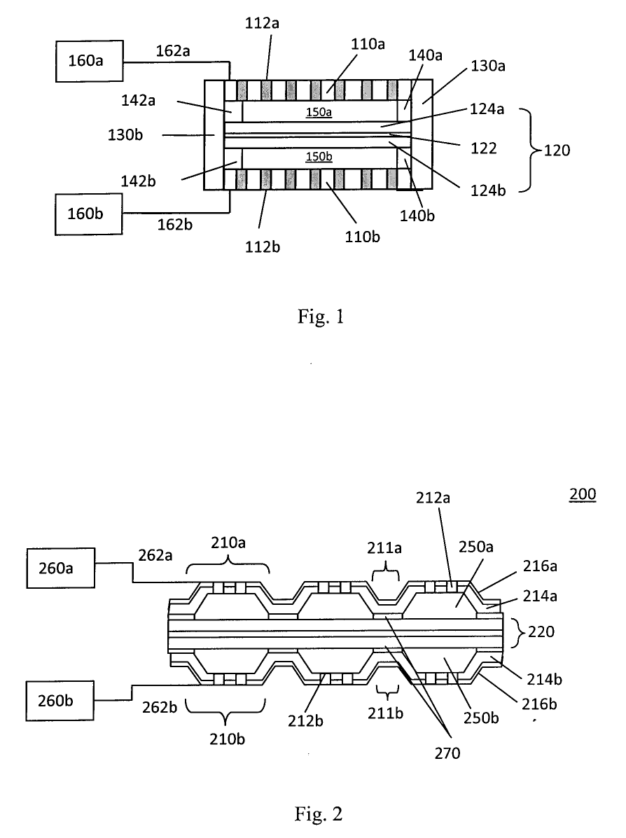

### DETAILED DESCRIPTION OF THE INVENTION

FIG. 2 illustrates an exemplary flexible electret actuator in examples consistent with the present invention. Referring to FIG. 2, the flexible electret actuator 200 may comprise first enclosures 210a, a first bendable elements 211a, second enclosures 210b, second bendable elements 211b and an electret diaphragm 220. The first enclosures 210a and the first bendable elements 211a may comprise a first flexible layer 214a and a first electrode 216a. The second enclosures 210b and the second bendable elements 211b may comprise a second flexible layer 214b and a second electrode 216b. The flexible layers 214a and 214b may be made of plastic materials with plasticity or blended fibers. In one example, the flexible layers 214a and 214b may be made of metal meshes or thin metal plates. The thickness of each flexible layer 214a and 214b may be in a range of about 20 micrometers to about 10,000 micrometers. The flexible layers 214a and 214b may be made by at least one of the processes, including but not limited to, injection molding, pressing, forging, plastic thermoforming, mechanical manufacturing and continuous roll-to-roll processes. The first and second electrodes 216a and 216b may be made from conductive materials such as gold, silver, aluminum, copper, chromium, platinum, indium tin oxide (ITO), silver paste, carbon paste or other conductive materials, or a combination of some of them. The thickness of each electrode 216a and 216b may be in a range of about 0.01 micrometers to about 100 micrometers. The first and second electrodes 216a and 216b may be coated on the first and second flexible layers 214a and 214b by, for example, spraying-coating, spin-coating, dip-coating, sputtering, evaporation, electroplating or a screen-printing process. When the flexible layers 214a and 214b may be made of metal meshes or thin metal plates to remove the need for the first and second electrodes 216a and 216b in some examples.

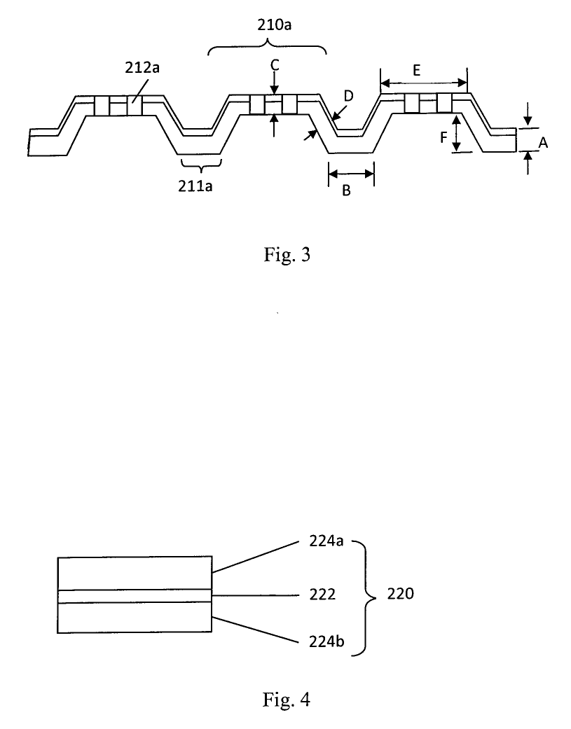

FIG. 3 shows details of the first enclosures 210a and the first bendable elements 211a. Note that the second enclosures 210b and second bendable element 211b may have corresponding configuration as described below. Each first enclosure 210a may have an upper portion with a width C, side portions with a width D and a number of acoustic holes 212a on the upper portion. The upper portion and the side portions of each first enclosure 210a may provide a cavity 205a ( [symbol] [symbol] with a width E and a length F. Each first bendable element 211a with a width B may have a thickness of A. The first bendable element 211a maybe made of bendable materials while the upper portion and the side portions of the first enclosures 210a may be made of rigid materials. As such, when the flexible electret actuator 200 is bent, the length F of the cavity 250a defined by the upper portion and the side portions remains the same. In other words, the first enclosures are substantially rigid to limit spacing variation between each first enclosure and the thin film area covering by the first enclosures when the flexible actuator is bent.

FIG. 4 shows the electret diaphragm 220 which may include a conductive layer 222, a first electret layer 224a and a second electret layer 224b. The conductive layer 222 may be made of gold, silver, aluminum, copper, chromium, platinum, indium tin oxide (ITO), silver paste, carbon paste or other conductive materials, or a combination of some of them. The conductive layer 222 may be coated on the electret layer 224b by, for example, spraying-coating, spin-coating, dip-coating, sputtering, evaporation, electroplating or a screen-printing process. In one example, the electret layers 224a and 224b may be made of at least one of the following materials: fluorinated ethylene propylene (FEP), poly tetrafluoroethylene (PTFE), cyclic olefin copolymer (COC), polychlorotrfluoroethylene (PCTFE), poly(ethylene-tetrafluoroethylene) (ETFE), Teflon AF, polyimide (PI), polyetherimide (PEI), polystyrene (PS), polycarbonate (PC), polymethylmethacrylate (PMMA), polyvinyl chloride (PVC), and tetrafluoroethylene-per-fluoromethoxyethylene copolymer (PFA). The electret layers 224a and 224b may store either positive charges or negative charges. The electret layers 224a and 224b may improve its charge storage stability by corona charge. The electret-metal-electret structure of the diaphragm 220 may be fabricated by a conventional process. In one example, the electret layer 224a may be formed on the conductive layer 222 and the electret layer 224b through vacuum thermal compression, ultrasonic pressing, mechanical compression or a roll-to-roll process to form an electret-metal-electret structure.

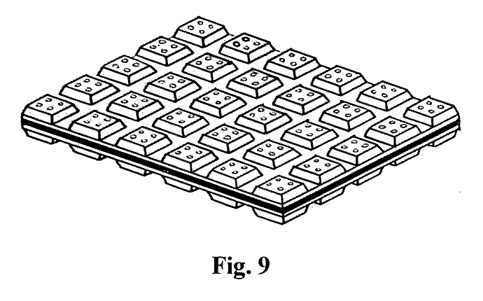

The electret diaphragm 220 may be placed between the first enclosures 210a and the second enclosures 210b by a process, such as a roll-to-roll pressing process or a large-area imprinting process. In that regard, the electret-metal-electret structure of the diaphragm 220 may be affixed to portions of the first bendable elements 211a and the second bendable elements 211b. In one example, the diaphragm 220 may be affixed to the first and second enclosures 210a and 210b by, for example, a thermal pressing process, ultrasonic pressing process, vacuum thermal compression, a roll-to-roll process or mechanical compression. In another example, the diaphragm 220 may be affixed to the first and second enclosures 210a and 210b by an adhesive element 270 (as shown in FIG. 2). In one example, the adhesive element 270 may be a double-sided adhesive tape, epoxy resin or instant adhesive glues. The first and second bendable elements 211a and 211b may hold and support the diaphragm 220 to provide its tension. Referring again to FIG. 2, the first enclosure 210a, the second enclosure 210b and the diaphragm 220 together provide a first cavity 250a and a second cavity 250b to ensure the efficiency of the diaphragm 220 and its displacement. The assembly of the first and second enclosures 210a and 210b and the diaphragm 220 may form a single unit of a flexible electret actuator 200. A number of the units arranged together may constitute a flexible electret actuator as shown in FIGS. 8 and 9.

In operation of a flexible electret actuator 200 of FIG. 2, each signal source 260a and 260b may output an equal and opposite alternating signal to the electrodes 216a and 216b via conductive lines 262a and 262b. The signals may cause a time-varying electric field to develop between the electrodes 216a and 216b and the electret layers 224a and 224b, thus resulting in a push-pull force. The push-pull force may cause the diaphragm 220 to vibrate. The resultant sound waves may pass through holes 212a and 212b and thus generating sound.

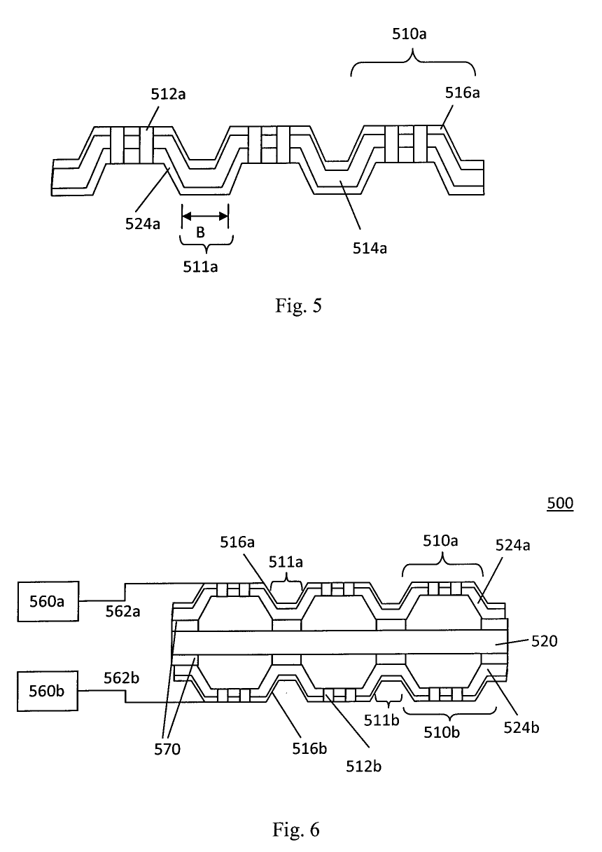

Another example consistent with the present invention provides a flexible electret actuator wherein the electret layer is included as part of the first enclosures and the first bendable element. In this example, a flexible electret actuator may include first enclosures 510a, first bendable elements 511a, second enclosures 510b and second bendable elements 511b. FIG. 5 shows details of the first enclosures 510a which may include an electrode 516a, a flexible layer 514a, an electret layer 524a, and acoustic holes 512a. Since the flexible layer 514a, the electret layer 524a, the electrode 516a and the acoustic holes 512a are same as those corresponding elements described in connection with FIGS. 2-4, description of these elements will not be repeated. In this example, the electret layer 524a may be provided under the flexible layer 514a by at least one of the processes, including spraying, ultrasonic pressing process, thermal pressing process or mechanical compression. When the electret layer 524a is made of plastic with plasticity, the flexible layer 514a may be omitted as shown in FIG. 6. In the examples of FIGS. 5 and 6, the electrostatic charges stored in electret layers 524a and 524b may be positive or negative.

Referring to FIG. 6, the diaphragm 520 may be made of at least one of the following materials: fluorinated ethylene propylene (FEP), cyclic olefin copolymer (COC), polyimide (PI), polyetherimide (PEI), polystyrene (PS), polycarbonate (PC), polymethylmethacrylate (PMMA), polyvinyl chloride (PVC), and poly(ethylene terephthalate (PET). The thickness of the diaphragm 520 may be in a range of about 0.5 micrometers to about 200 micrometers. The diaphragm 520 may be coated with a conductive film to form a conductive diaphragm 520 by, for example, a spraying-coating, spin-coating, dip-coating, sputtering, evaporation, electroplating or screen-printing process. In one example, the conductive layer may be gold, silver, aluminum, copper, chromium, platinum, indium tin oxide (ITO), silver paste, carbon paste or other conductive materials.

Referring again to FIG. 6, the conductive diaphragm 520 may be affixed to portions of the first bendable element 511 a and the second bendable element 511b in the same way as described in connection with FIGS. 2-4 above. In addition, a flexible electret actuator 500 of FIG. 6 operates the same as described in connection with FIGS. 2-4.

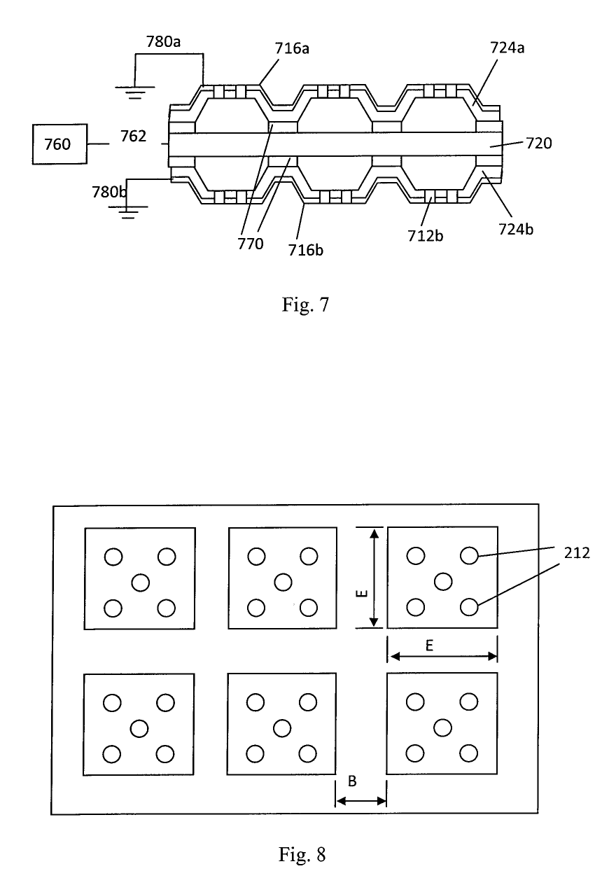

FIG. 7 illustrates another example in consistent with the present invention. The flexible electret actuator 700 is the same as the flexible electret actuator 500 of FIG. 6 except that one of the electret layers 724a and 724b stores positive charge and the other stores negative charges. In this example, electrodes 716a and 716b are connected to ground via conductive lines 780a and 780b. In operation of a flexible electret actuator of FIG. 7, the signal source 760 may output an alternating signal to the conductive diaphragm 720 via conductive line 762. The signal may cause a time-varying electric field to develop between the conductive diaphragm 720 and the electret layers 724a and 724b, thus resulting in a push-pull force. The push-pull force may cause the diaphragm 720 to vibrate. The resultant sound waves may pass through holes 712a and 712b and thus generating sound.

It will be appreciated by those skilled in the art that changes could be made to the examples described above without departing from the broad inventive concept thereof. It is understood, therefore, that this invention is not limited to the particular examples disclosed, but it is intended to cover modifications within the spirit and scope of the present invention as defined by the appended claims.

We claim:

1. A flexible actuator, comprising:
a thin film comprising a conductive layer and a first electret layer over a first surface of the conductive layer, the thin film is configured to be bendable; and
at least one first enclosure with at least one first bendable element coupled to the first enclosure, the first enclosure having a first electrode layer and being provided over the first electret layer with the first electrode layer being spaced apart from the first electret layer, the first electrode layer being coupled with a first terminal of an audio signal input,
wherein the thin film is configured to interact with the first enclosure in response to audio signals supplied by the audio signal input and to generate sound waves.

2. The flexible actuator of claim 1, wherein the at least one first enclosure is substantially rigid to limit spacing variation between the first enclosure and thin film area covered by the first enclosure when the flexible actuator is bent.

3. The flexible actuator of claim 1, wherein the at least one first enclosure comprises a number of openings for allowing the sound waves to pass through.

4. The flexible actuator of claim 1, wherein the at least one first enclosure is provided over the thin film with an adhesive layer between a portion of the first bendable element and the thin film.

5. The flexible actuator of claim 1, wherein the at least one first enclosure is provided over the thin film by at least one of ultrasonic pressing, thermal pressing, vacuum thermal compression, mechanical compression, and a roll-to-roll process.

6. The flexible actuator of claim 1, wherein the at least one first enclosure and the at least one first bendable element comprise a first flexible layer made of at least one of plastic materials with plasticity and blended fibers at different thicknesses.

7. The flexible actuator of claim 6, wherein the first flexible layer is in a thickness between about 20 micrometers and 10,000 micrometers.

8. The flexible actuator of claim 1, further comprising at least one second enclosure with at least one second bendable element coupled to the second enclosure, the second enclosure having a second electrode layer and being provided over the thin film at a side opposed to the first enclosure with the second electrode layer being spaced apart from the thin film, the second electrode layer being coupled with a second terminal of the audio signal input, wherein the thin film is configured to interact with the first and second enclosures in response to the audio signals supplied by the audio signal input and to generate the sound waves.

9. The flexible actuator of claim 1, further comprising at least one second enclosure with at least one second bendable element coupled to the second enclosure, the second enclosure having a second electrode layer and being provided over the thin film at a side opposed to the first enclosure with the second electrode layer being spaced apart from the thin film, the second electrode layer being coupled with a terminal of a second audio signal input, wherein the thin film is configured to interact with the first and second enclosures in response to the audio signals supplied by the audio signal input and the second audio signal input and to generate the sound waves.

10. The flexible actuator of claim 1, wherein the first electrode layer is in a thickness between about 0.01 micrometers and 100 micrometers.

11. The flexible actuator of claim 1, wherein the conductive layer is made of at least one of gold, silver, aluminum, copper, chromium, platinum, indium tin oxide (ITO), silver paste, carbon paste and other conductive materials.

12. The flexible actuator of claim 1, wherein the first electret layer is made of at least one of fluorinated ethylene proylene (FEP), poly tetrafluoroethylene (PTFE), cyclic olefin copolymer (COC), polychlorotrfluoroethylene (PCTFE), poly(ethylene-tetrafluoroethylene) (ETFE), Teflon AF, polyimide (PI), polyetherimide (PEI), polystyrene (PS), polycarbonate (PC), polymethylmethacrylate (PMMA), polyvinyl chloride (PVC), and tetrafluoroethylene-per-fluoromethoxyethylene copolymer (PFA).

13. The flexible actuator of claim 1, wherein the thin film further comprises a second electret layer over a second surface of the conductive layer, wherein the conductive layer is sandwiched between the first electret layer and the second electret layer to form an electret-metal-electret structure.

14. A flexible actuator, comprising:
a thin film comprising a conductive layer, the thin film being configured to be bendable;
at least one first enclosure with at least one first bendable element coupled to the first enclosure, the first enclosure having a first electrode layer and a first electret layer as part of the first enclosure, the first enclosure being coupled with a first terminal of an audio signal input,
wherein the thin film is configured to interact with the first enclosure in response to audio signal supplied by the audio signal input and to generate sound waves.

15. The flexible actuator of claim 14, wherein the at least one first enclosure is substantially rigid to limit spacing variation between the first enclosure and thin film area covered by the first enclosure when the flexible actuator is bent.

16. The flexible actuator of claim 14, wherein the at least one first enclosure comprises a number of openings for allowing the sound waves to pass through.

17. The flexible actuator of claim 14, wherein the at least one first enclosure is provided over the thin film with an adhesive layer between a portion of the first bendable element and the thin film.

18. The flexible actuator of claim 14, wherein the at least one first enclosure is provided over the thin film by at least one of ultrasonic pressing, thermal pressing, vacuum thermal compression, mechanical compression, and a roll-to-roll process.

19. The flexible actuator of claim 14, wherein the at least one first enclosure and the first bendable element comprise a first flexible layer made of at least one of plastic materials with plasticity and blended fibers at different thicknesses.

20. The flexible actuator of claim 19, wherein the first flexible layer is in a thickness between about 20 micrometers and 10,000 micrometers.

21. The flexible actuator of claim 14, further comprising at least one second enclosure with at least one second bendable element coupled to the second enclosure, the second enclosure having a second electrode layer and at least one second electret layer, the second enclosure being provided over the thin film at a side opposed to the first enclosure, the second electrode layer being coupled with a second terminal of the audio signal input, wherein the thin film is configured to interact with the first and second enclosures in response to the audio signals supplied by the audio signal input and to generate the sound waves.

22. The flexible actuator of claim 14, further comprising at least one second enclosure with at least one second bendable element coupled to the second enclosure, the second enclosure having a second electrode layer and at least one second electret layer, the second enclosure being provided over the thin film at a side opposed to the first enclosure, the second electrode layer being coupled with a terminal of a second audio signal input, wherein the thin film is configured to interact with the first and second enclosures in response to the audio signals supplied by the audio signal input and the second audio signal input and to generate the sound waves.

23. The flexible actuator of claim 14, wherein the first electrode layer is in a thickness between about 0.01 micrometers and 100 micrometers.

24. The flexible actuator of claim 14, wherein the conductive layer of the thin film is coupled with a second terminal of the audio signal input.

25. The flexible actuator of claim 14, wherein the conductive layer is made of at least one of gold, silver, aluminum, copper, chromium, platinum, indium tin oxide (ITO), silver paste, carbon paste and other conductive materials.

26. The flexible actuator of claim 14, wherein the first electret layer is made of at least one of fluorinated ethylene proylene (FEP), poly tetrafluoroethylene (PTFE), cyclic olefin copolymer (COC), polychlorotrfluoroethylene (PCTFE), poly(ethylene-tetrafluoroethylene) (ETFE), Teflon AF, polyimide (PI), polyetherimide (PEI), polystyrene (PS), polycarbonate (PC), polymethylmethacrylate (PMMA), polyvinyl chloride (PVC), and tetrafluoroethylene-per-fluoromethoxyethylene copolymer (PFA).
